(19) United States
(12) Patent Application Publication
(10) Pub. No.: US 2025/0030030 A1
(43) Pub. Date: Jan. 23, 2025

(54) DEVICE FOR GENERATING ELECTRICITY THROUGH MULTI-TYPE ION CONTROL BASED ON DONNAN EFFECT, AND ELECTRICITY GENERATING DEVICE HAVING LAMINATED STRUCTURE

(71) Applicant: Korea University Research and Business Foundation, Seoul (KR)

(72) Inventors: Chang Soo HAN, Seoul (KR); Jung Soo KIM, Seoul (KR)

(73) Assignee: Korea University Research and Business Foundation, Seoul (KR)

(21) Appl. No.: 18/714,739

(22) PCT Filed: May 30, 2022
(86) PCT No.: PCT/KR2022/007628

§ 371 Date: May 30, 2024

(30) Foreign Application Priority Data
Dec. 7, 2021 (KR) 10-2021-0174250

(51) Int. Cl. H01M 8/22; H01M 8/18

(52) U.S. Cl. CPC H01M 8/227; H01M 8/18; H01M 2300/0011

(57) ABSTRACT

Disclosed is an electricity generation device. The present invention provides an electricity generation device, including: a first electrolyte, selectively permeable membrane, and second electrolyte in a chamber thereof, wherein each of the first electrolyte and the second electrolyte includes at least two types of ions, and at least three types of ions are included in the first electrolyte and the second electrolyte, the selectively permeable membrane selectively permeates at least one type of ions among the at least three types of ions to cause Donnan effect between the first electrolyte and the second electrolyte.

### TECHNICAL FIELD

The present invention relates to an electricity generation device using multi-ion control based on the Donnan effect and having a laminated structure, and more particularly to an electricity generation device using multi-ion control based on the Donnan effect and having a laminated structure, the electricity generation device capable of outputting higher current and power density, compared to existing reverse electrodialysis technology, by using two electrolytes (first electrolyte and second electrolyte) containing high concentrations of multiple ions, thereby having excellent electrical characteristics.

### BACKGROUND ART

Reverse electrodialysis is a system that generates electricity by the behavior of ions when the concentrations of two adjacent electrolytes are different and a selective membrane with high permeability to specific ions contained in the two electrolytes is placed adjacent to the electrolytes. The two electrolytes are composed of a high-concentration electrolyte and a low-concentration electrolyte, and generate an electric potential in a three-layer structure with a selectively permeable membrane such as a cation-permeable membrane or an anion-permeable membrane placed between the electrolytes.

Since the cation permeable membrane and the anion-permeable membrane form electric potentials in opposite directions for both the same electrolytes, an electric potential added in the same direction can be obtained by laminating the high-concentration electrolyte, the cation-permeable membrane, the low-concentration electrolyte, the anion-permeable membrane, and the high-concentration electrolyte in that order. Moreover, a larger electric potential can be obtained by repeatedly laminating the three-layer structure alternately as a unit.

The obtained larger electric potential causes a redox reaction in the electrode when inserting an electrode into electrolytes at opposite ends of the entire laminated structure, thereby supplying electrical energy to an external circuit. That is, it is an electric energy supply and generation device that converts the chemical potential due to concentration differences into electric potential by controlling the flow of ions. Research on renewable energy generation and harvesting that treats the high-concentration electrolyte as seawater and treats the low-concentration electrolyte as freshwater and uses reverse electrodialysis technology is actively being conducted.

However, an existing reverse electrodialysis technology essentially includes the low-concentration electrolyte as a component thereof. The low-concentration electrolyte is commonly freshwater or an electrolyte with a concentration (0.01 M) similar to freshwater, which causes low-density ionic currents and has limitations in increasing power density. To improve the power density, studies have been proposed to improve the power density by improving the selectivity of the selectively permeable membranes to strengthen the flow of specific ions, but fundamentally, the cause of the low power density is the presence of the low-concentration electrolyte. Accordingly, it is difficult to dramatically improve the power density.

In addition, the reverse electrodialysis technology continuously generates and discharges electrical energy in a state that is not in equilibrium because the low-concentration electrolyte and the high-concentration electrolyte are adjacent to each other. The high-concentration electrolyte, which is commonly used with seawater or an electrolyte with a concentration similar to seawater (0.5 M), and the low-concentration electrolyte have a concentration difference of about 50 times, and ions flowing along the concentration gradient and the rapid flow of water due to strong osmotic pressure can quickly reduce this concentration difference. To prevent this and stably control electrical energy generation, there is a burden of continuously injecting electrolytes of the same concentration into the two electrolytes with a separate external pump device to circulate them to maintain the concentration difference.

Meanwhile, electrical energy generation in living bodies also occurs by controlling the flow of ions. The cell membrane selectively transmits ions around the cell membrane through ion channels, controlling ion behavior and generating electric potential. Inside and outside cells, various ions, such as K⁺, Cl⁺, Na⁺, Ca²⁺, Mg²⁺, H⁺ and HCO₃⁻, and an anionic protein (P⁻) are distributed at different concentrations.

Various types of ions are contained differently with a concentration difference of up to several tens of times inside and outside cells, but the total concentrations inside and outside cells are similar. In this environment surrounding the cell membrane, only specific ion selectively permeate through ion channels located within the cell membrane. There is little difference in the total concentrations, but flow according to the concentration gradient of specific ions is activated by the ion channels, and other ions whose flow is inhibited form an ion layer around the membrane, forming an electrical gradient, i.e., an electric potential.

The generated electrical gradient is in equilibrium with the concentration gradient and maintains the difference in the concentrations of ions. This is called the Donnan effect. Here, an equilibrium potential is called the Donnan potential. The bioelectric mechanism generated by ion transport plays an important role in metabolism and the nervous system in vivo, and is characterized by excellent energy efficiency and output and fast response speed, so research is continuing to identify the detailed mechanism.

### DETAILED DESCRIPTION

### Technical Problem

Therefore, the present invention has been made in view of the above problems, and it is one object of the present invention to provide an electricity generation device using multi-ion control based on the Donnan effect and having a laminated structure, the electricity generation device being capable of outputting higher current and power density, compared to existing reverse electrodialysis technologies, by using a selectively permeable membrane and two electrolytes (first electrolyte and second electrolyte) containing high concentrations of multiple ions and, thus, having excellent electrical characteristics.

It is another object of the present invention to provide an electricity generation device using multi-ion control based on the Donnan effect and having a laminated structure, wherein the first electrolyte and second electrolyte of the electricity generation device have different ion compositions or concentration compositions, but similar total concentrations, thereby forming a quasi-equilibrium state due to a low osmotic pressure of the two electrolytes (the first electrolyte and the second electrolyte) and Donan effect and, thus, having excellent electrochemical stability.

### Technical Solution

In accordance with an aspect of the present invention, the above and other objects can be accomplished by the provision of an electricity generation device, including: a first electrolyte, selectively permeable membrane, and second electrolyte in a chamber thereof, wherein each of the first electrolyte and the second electrolyte includes at least two types of ions, and at least three types of ions are included in the first electrolyte and the second electrolyte, the selectively permeable membrane selectively permeates at least one type of ions among the at least three types of ions to cause Donnan effect between the first electrolyte and the second electrolyte.

In the selectively permeable membrane, a permeability (P_{other ions}/P_{selected ions}) of other types of ions relative to a permeability of one type of ions that selectively permeate the selectively permeable membrane may be 0 to 0.5.

At least one type of ions, which permeate the selectively permeable membrane, among at least three types of ions included in the first electrolyte and the second electrolyte may be present at different concentrations in the first electrolyte and the second electrolyte.

With regard to the different concentrations between the first electrolyte and the second electrolyte, a ratio (C_{low concentration}/C_{high concentration}) of a concentration of at least one type of ions, which permeate the selectively permeable membrane, included in an electrolyte in which at least one type of ions permeating the selectively permeable membrane is included in a relatively small content to a concentration of at least one type of ions, which permeate the selectively permeable membrane, included in an electrolyte in which at least one type of ions permeating the selectively permeable membrane are contained in a relatively large amount may be 0 to 0.1.

A total concentration ratio (C_{second electrolyte}/C_{first electrolyte}) of the first electrolyte to the second electrolyte may be 0.1 to 10.

The first electrolyte may include cations and anions, wherein the cations include at least one of H⁺, Na⁺, K⁺, Mg²⁺, Ca²⁺, Li⁺, Fe³⁺, Fe²⁺, Al³⁺, Cu²⁺, Zn²⁺, Zn⁺, V²⁺, V³⁺, Cr²⁺, Cr³⁺, Co(NH₃)₆³⁺ and (CH₃)ₙNHₘ⁺ (n and m are from 0 to 4, and the sum of n and m is 4), and the anion includes at least one F⁻, Cl⁻, Br⁻, NO₃⁻, OH⁻, F⁻, Br⁻, HCO₃⁻, SO₄²⁻ and CO₃²⁻.

The selectively permeable membrane may include a selectively permeable composite membrane including a first selectively permeable sub-membrane and second selectively permeable sub-membrane combined in parallel.

A thickness of the first electrolyte and the second electrolyte may be 0.1 mm to 1 mm.

A thickness of the selectively permeable membrane may be 0.1 μm to 1 mm.

An electrode may be further included in at least one of the first electrolyte and the second electrolyte.

In accordance with an aspect of the present invention, the above and other objects can be accomplished by the provision of an electricity generation device with a laminated structure, the electricity generation device including: a first electrolyte, selectively permeable membrane, and second electrolyte in a chamber thereof, wherein the first electrolyte, the selectively permeable membrane and the second electrolyte are alternately and repeatedly stacked in a laminated structure, each of the first electrolyte and the second electrolyte includes at least two types of ions, and at least three types of ions are included in the first electrolyte and the second electrolyte, the selectively permeable membrane selectively permeates at least one type of ions among the at least three types of ions to cause Donnan effect between the first electrolyte and the second electrolyte.

The selectively permeable membrane may be composed of at least two membranes.

The selectively permeable membrane may include a first selectively permeable membrane and a second selectively permeable membrane, wherein the first selectively permeable membrane and the second selectively permeable membrane selectively permeate different types of ions and form electric potential in a same direction.

### Advantageous Effects

In accordance with an embodiment of the present invention, provided is an electricity generation device using multi-ion control based on the Donnan effect and having a laminated structure, the electricity generation device being capable of outputting higher current and power density, compared to existing reverse electrodialysis technologies, by using a selectively permeable membrane and two electrolytes (first electrolyte and second electrolyte) containing high concentrations of multiple ions and, thus, having excellent electrical characteristics.

An embodiment of the present invention can provide an electricity generation device using multi-ion control based on the Donnan effect and having a laminated structure, wherein the first electrolyte and second electrolyte of the electricity generation device have different ion compositions or concentration compositions, but similar total concentrations, thereby forming a quasi-equilibrium state due to a low osmotic pressure of the two electrolytes (the first electrolyte and the second electrolyte) and Donan effect and, thus, having excellent electrochemical stability.

### DESCRIPTION OF DRAWINGS

FIG. 1 is a sectional view illustrating an electricity generation device according to an embodiment of the present invention.

FIG. 2 is a schematic diagram illustrating the mechanism of an electricity generation device according to an embodiment of the present invention with a three-layer laminated structure including a selectively permeable single membrane.

FIG. 3 is a sectional view illustrating an electricity generation device according to an embodiment of the present invention including a selectively permeable composite membrane.

FIGS. 4 and 5 are schematic diagrams illustrating the mechanism of the electricity generation device according to an embodiment of the present invention including a selectively permeable composite membrane.

FIGS. 6 and 7 are sectional views illustrating electricity generation devices according to an embodiment of the present invention laminated in a laminated structure.

FIGS. 8 to 10 are schematic diagrams illustrating the mechanism of the electricity generation device with a laminated structure according to an embodiment of the present invention.

FIG. 11 illustrates sectional views for comparing an existing reverse electrodialysis technology and the electricity generation device with a laminated structure according to an embodiment of the present invention, and FIG. 12 are schematic diagram for comparing an existing reverse electrodialysis technology and the electricity generation device according to an embodiment of the present invention.

FIG. 13 illustrates the electric potentials of the electricity generation device according to Comparative Example 1 and the electricity generation device of Example 1 according to the present invention.

FIG. 14 illustrates the electrochemical stability of the electricity generation devices according to Comparative Examples 2 to 4 and of the electricity generation device according to Example 2 of the present invention, and FIG. 15 illustrates the voltage-current characteristics of the electricity generation devices according to Comparative Examples 2 to 4 and of the electricity generation device according to Example 2 of the present invention.

FIG. 16 illustrates the osmotic pressure characteristics of the electricity generation devices according to Comparative Examples 2 to 4 and of the electricity generation device according to Example 2 of the present invention.

FIG. 17 illustrates the current density characteristics of the electricity generation device (Binary) according to Comparative Example 4 and of the electricity generation device (Quaternary) according to Example 2 of the present invention.

### BEST MODE

The present invention will now be described more fully with reference to the accompanying drawings and contents disclosed in the drawings. However, the present invention should not be construed as limited to the exemplary embodiments described herein. The terms used in the present specification are used to explain a specific exemplary embodiment and not to limit the present inventive concept. Thus, the expression of singularity in the present specification includes the expression of plurality unless clearly specified otherwise in context.

It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive of” rather than “exclusive of”. That is, unless otherwise mentioned or clearly inferred from context, the expression “x uses a or b” means any one of natural inclusive permutations.

In addition, as used in the description of the invention and the appended claims, the singular forms “a”, “an” and “the” are intended to include the plural forms as well, unless context clearly indicates otherwise.

Although terms used in the specification are selected from terms generally used in related technical fields, other terms may be used according to technical development and/or due to change, practices, priorities of technicians, etc.

Therefore, it should not be understood that terms used below limit the technical spirit of the present invention, and it should be understood that the terms are exemplified to describe embodiments of the present invention.

Also, some of the terms used herein may be arbitrarily chosen by the present applicant.

In this case, these terms are defined in detail below. Accordingly, the specific terms used herein should be understood based on the unique meanings thereof and the whole context of the present invention.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

Meanwhile, in the following description of the present invention, a detailed description of known functions and configurations incorporated herein will be omitted when it may make the subject matter of the present invention unclear.

The terms used in the specification are defined in consideration of functions used in the present invention, and can be changed according to the intent or conventionally used methods of clients, operators, and users. Accordingly, definitions of the terms should be understood on the basis of the entire description of the present specification.

An electricity generation device according to an embodiment of the present invention is an electricity generation device including a first electrolyte, a selectively permeable membrane, and a second electrolyte in a chamber thereof. The electricity generation device according to an embodiment of the present invention can output higher current and power density, compared to existing reverse electrodialysis technology, by using the selectively permeable membrane, and two electrolytes (the first electrolyte and the second electrolyte) containing high concentrations of multiple ions, thereby having excellent electrical characteristics.

According to an embodiment, the electricity generation device according to an embodiment of the present invention may include a selectively permeable single membrane, or a selectively permeable composite membrane including at least two selectively permeable sub-membranes.

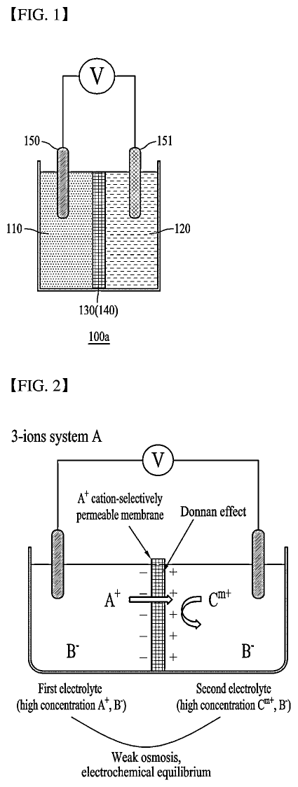

FIGS. 1 and 2 are schematic diagrams illustrating an electricity generation device having a three-layer laminated structure that includes a selectively permeable single membrane, and its mechanism, and FIGS. 3 to 5 are schematic diagrams illustrating an electricity generation device having a three-layer laminated structure that includes a selectively permeable composite membrane including two or more selectively permeable sub-membranes, and its mechanism.

That is, the electricity generation devices according to embodiments of the present invention include the same components except that the number and structures of the selectively permeable membrane are different, so the same components are described with reference to FIG. 1.

FIG. 1 is a sectional view illustrating an electricity generation device according to an embodiment of the present invention.

An electricity generation device 100a according to an embodiment of the present invention includes a first electrolyte 110, selectively permeable membrane 130, 140 and second electrolyte 120 in a chamber thereof.

Therefore, the electricity generation device 100a according to an embodiment of the present invention can output higher current and power density, compared to existing reverse electrodialysis technology, by using the selectively permeable membrane 130, 140, and the two electrolytes (the first electrolyte and the second electrolyte) containing high concentrations of multiple ions, thereby having excellent electrical characteristics.

The electricity generation device 100a according to an embodiment of the present invention includes the first electrolyte 110 and the second electrolyte 120, each of the first electrolyte 110 and the second electrolyte 120 includes at least two types of ions, and the total of ions contained in the first electrolyte 110 and the second electrolyte 120 is at least three types.

The electricity generation device 100a according to an embodiment of the present invention uses high-concentration electrolytes containing different types of ions as the first and second electrolytes 110 and 120 instead of conventionally used high-concentration electrolyte and low-concentration electrolyte, so the two types of high-concentration electrolytes contain a total of three or more types of ions. The selectively permeable membrane 130, 140 for selectively permeating only one type of ions among the constituting ions with a higher permeability than other types of ions is placed between the first electrolyte 110 and the second electrolyte 120.

Accordingly, the Donnan effect can be induced between the two high-concentration electrolytes, thereby providing excellent electrical characteristics and a stable electrochemical system.

The electricity generation device 100a according to an embodiment of the present invention includes the first electrolyte 110.

The first electrolyte 110 may include at least two types of ions, preferably, 2 to 10 types of ions.

The first electrolyte 110 may include at least one cation and at least one anion. For example, the cation may include at least one of H⁺, Na⁺, K⁺, Mg²⁺, Ca²⁺, Li⁺, Fe³⁺, Fe²⁺, Al³⁺, Cu²⁺, Zn²⁺, Zn⁺, V²⁺, V³⁺, Cr²⁺, Cr³⁺, Co(NH₃)₆³⁺ and (CH₃)ₙNHₘ⁺ (n and m are 0 to 4, and the sum of n and m is 4), and the anion may include at least one of F⁻, Cl⁻, Br⁻, NO₃⁻, OH⁻, F⁻, Br⁻, HCO₃⁻, SO₄²⁻ and CO₃²⁻, but the cation and the anion are not limited to the indicated types.

Preferably, the first electrolyte 110 may contain KCl having a similar level of ion mobility between cations and anions and an excellent size, but the first electrolyte 110 may be replaced with another type of ions depending on the characteristics of a solvent contained in the first electrolyte 110 or the ion selectivity of the selectively permeable membrane 130, 140.

The total concentration of the first electrolyte 110 may be high to accomplish high electrical conductivity. Preferably, the total concentration of the first electrolyte 110 may be 0.1 M to 5 M, preferably, 0.1 M to 2 M.

As for the definition of high concentration, in many studies, freshwater is generally replaced with 0.01 M electrolyte and salt water is generally replaced with 0.5 M electrolyte. Considering 0.01 M electrolyte, which is expressed as freshwater, as a low concentration, 0 M to 0.1 M is defined as a low concentration. Considering 0.5 M electrolyte, which is expressed as salt water, as a high concentration, a high concentration may be defined as 0.1 M or more, preferably, 0.1 M to 5 M may be defined as a high concentration.

In addition, the concentrations of at least two types of ions contained in the first electrolyte 110 may be the same or different. When the concentrations of at least two or more types of ions included in the first electrolyte 110 are different, a ratio (C_{low concentration}/C_{high concentration}) of the concentration of at least one type of ions that permeate the selectively permeable membrane 130, 140 contained in the electrolyte (the first electrolyte or the second electrolyte) in which at least one type of ions permeating the selectively permeable membrane 130, 140 are contained in a relatively small amount to the concentration of at least one type of ions that permeate the selectively permeable membrane 130, 140 of the electrolyte (the second electrolyte or the first electrolyte) in which at least one type of ions permeating the selectively permeable membrane 130, 140 are contained in a relatively large amount, i.e., the concentration ratio of the selected ions, may be 0 to 0.1.

When the concentration ratio of the selected ions (C_{low concentration}/C_{high concentration}) is higher than 0.1, a weak electric potential occurs. In addition, it is desirable that the total concentration of the total concentrations of the first electrolyte 110 and the second electrolyte 120 are at a similar level because the osmosis phenomenon is expected to be reduced. Here, whereas the total concentration ratio (C_{second electrolyte}/C_{first electrolyte}) of the first electrolyte 110 to the second electrolyte 120 according to an existing technology is at different levels of 50 to 0.02, the total concentration ratio (C_{second electrolyte}/C_{first electrolyte}) of the first electrolyte 110 to the second electrolyte 120 may be at a similar level of 0.1 to 10. When exceeding the total concentration ratio, the difference in concentration is similar to that of the existing technology, causing osmosis problems like the existing technology.

In addition, even if the concentrations of at least two or more types of ions included in the first electrolyte 110 are different, the total concentration of the ions contained in the first electrolyte 110 may be high as described above.

More specifically, when two types of ions (one type of cations and one type of anions) are included in the first electrolyte 110, the two types of ions have a concentration in the ratio of the reciprocal of the absolute value of the charge to achieve electrical neutrality. The first electrolyte 110 has a high concentration of ions permeating the selectively permeable membrane 130, 140 to have a high total concentration, and the second electrolyte 120 has a low concentration of selected ions according to the concentration ratio condition (0<C_{low concentration}/C_{high concentration}<0.1) of the selected ions. Meanwhile, the second electrolyte 120 has a high concentration of other ions of the same polarity (positive/negative) as the selected ions to reduce the total concentration ratio difference (0.1<C_{second electrolyte}/C_{first electrolyte}<10). Meanwhile, ions of a different polarity (positive/negative) from the selected ions have a concentration in the ratio of the reciprocal of the absolute value of the charge to match the electrical neutrality of the ions of each of the two electrolytes.

In addition, when the first electrolyte 110 contains three types of ions, one type of ions selected by the selectively permeable membrane 130, 140 may be contained at a different concentration from the second electrolyte 120.

For example, when the first electrolyte 110 includes three types of ions and other ions having the same polarity (positive/negative) as ions selected by the selectively permeable membrane 130, 140, the concentrations of ions selected according to the concentration ratio condition of the selected ions (0<C_{low concentration}/C_{high concentration}<0.1) are different in the two electrolytes, and, to reduce the total concentration ratio difference between the two electrolytes (0.1<C_{second electrolyte}/C_{first electrolyte}<10), the concentration of other ions having the same polarity as the selected ions may be different in an opposite concentration ratio in the two electrolytes, as opposed to the selected ions.

This is desirable to make the total concentration of the two electrolytes similar. If the selected ions and other ions of the same polarity do not have different concentrations, the total concentrations may also be different, causing osmosis problems. Therefore, the first electrolyte 110 contains three types of ions, and if other ions with the same polarity as ions selected from the ions are included, the concentrations of these ions may be different. However, as long as the concentrations of the selected ions of the two electrolytes are different, but the total concentrations are at a similar level, it is not a necessary condition for the concentrations of other types of ions to be different.

In addition, when the first electrolyte 110 contains three types of ions and the ions do not contain other ions having the same polarity as ions selected by the selectively permeable membrane 130, 140, the concentration of the other types of ions is sufficient if the total concentrations of the first electrolyte 110 and the second electrolyte 120 are at similar levels. However, when there are no other ions of the same polarity, the first electrolyte 110 has a high concentration of ions permeating the selectively permeable membrane 130, 140 to have a high total concentration, and the second electrolyte 120 has a low concentration of selected ions according to the concentration ratio condition (0<C_{low concentration}/C_{high concentration}<0.1) of the selected ions. Meanwhile, the second electrolyte 120 has a high concentration of other ions of the same polarity (positive/negative) as the selected ions to reduce the total concentration ratio difference (0.1<C_{second electrolyte}/C_{first electrolyte}<10). Meanwhile, ions of a different polarity (positive/negative) from the selected ions have a concentration in the ratio of the reciprocal of the absolute value of the charge to match the electrical neutrality of the ions of each of the two electrolytes.

Meanwhile, even if the first electrolyte 110 is an electrolyte that contains ions, selected by the selectively permeable membrane, at a low concentration, i.e., even if it acts as a low-concentration electrolyte in the existing technology, the first electrolyte 110 must contain other ions of the same polarity and the ions are included at high concentrations, so the total concentration of the first electrolyte 110 may be high.

For example, when the first electrolyte 110 contains no K⁺ ions or K⁺ ions at a low concentration of 0.01 M in response to a selectively permeable membrane that selects K⁺ ions, and the second electrolyte 120 contains K⁺ ions at a high concentration of 1 M at different concentrations, the first electrolyte contains 0.7 M Mg²⁺ ions, another ion of the same polarity, so both the electrolytes may be at high concentration.

Meanwhile, if both the electrolytes contain only Cl⁻ ions, the first electrolyte 110 is 1.41 M, the second electrolyte 120 is 1 M, and the total concentrations of the two electrolytes are 2.12 M and 2 M, respectively, which are at a similar level and greatly hinder the osmosis problem.

The unselected ions, Mg²⁺ or Cl⁻, are not directly related to the electric potential value, and a larger electric potential may be obtained through a large concentration difference between the two electrolytes of K⁺.

In addition, the present invention, in which all electrolytes can be of high concentration, can be expected to have improved electrical performance, unlike the existing technology that must contain a low concentration.

According to an embodiment, the first electrolyte 110 contains K⁺ ions at a low concentration of 0.01 M in response to the selectively permeable membrane that selects K⁺ ions, and when the second electrolyte 120 contains K⁺ ions at a high concentration of 1 M, the first electrolyte contains Mg²⁺ ions as other types of ions having the same polarity at a concentration of 0.7 M, and the second electrolyte 120 contains Mg²⁺ at a concentration of 0.04 M, so both the two electrolytes are at a high concentration. Meanwhile, with regard to the anions, when both the two electrolytes contain only Cl⁻ ions, the first electrolyte is 1.41 M, and the second electrolyte 120 is 1.08 M, so the total concentrations of the two electrolytes approach almost 2.12 M and 2.12 M, respectively and the osmosis problem is greatly reduced.

non-selected ions, Mg²⁺ or Cl⁻, are not directly related to the electric potential value, and a larger electric potential can be obtained due to a large concentration difference of K⁺ between the two electrolytes. In addition, the present invention in which all electrolytes can be of high concentration can provide improved electrical performance unlike existing technologies that must contain a low-concentration electrolyte.

According to an embodiment, when the first electrolyte 110 does not contain K⁺ ions in response to the selectively permeable membrane that selects K⁺ ions, and the second electrolyte 120 contains K⁺ ions at a high concentration of 0.5 M, i.e., the K⁺ ions are contained at different concentrations, the first electrolyte 110 contain 0.5 M Mg²⁺ ions as other types of ions having the same polarity, so all the two electrolytes may contain ions at a high concentration.

Meanwhile, with regard to the anions, when the two electrolytes contain SO₄²⁻ and Cl⁻ ions, the concentration of the first electrolyte is 0.5 M, and the concentration of the second electrolyte is 0.5 M, so the total concentrations of the two electrolytes are the same 1 M and 1 M, respectively and the osmosis problem is greatly reduced. Non-selected ions, Mg² or Cl⁻, do not involve in an electric potential value, and a larger electric potential may be obtained due to a large concentration difference of K⁺ between the two electrolytes.

Meanwhile, the ions composition and concentration conditions of the first and second electrolytes 110 and 120 may be mutually changed without being limited to the ions composition or concentration of the above-described examples.

In addition, the present invention in which all electrolytes can be of high concentration can provide improved electrical performance, unlike existing technologies in which an electrolyte of a low concentration must be included.

The first electrolyte 110 may include a solvent. The solvent is preferably common water (H₂O), but may include at least one of a strong acid/strong base, which can easily dissolve, and an organic solvent electrolyte depending upon of ions and salt contained in the first electrolyte 110.

More preferably, the solvent may be an electrolyte solution with a high dielectric constant to facilitate ionization of a solute and a salt and a low viscosity to facilitate ion movement.

The strong acid/strong base may include at least one of HCl, H₂SO₄ and KOH, and the organic solvent may include at least one of linear carbonate, chain carbonate and cyclic carbonate, without being limited thereto.

According to an embodiment, the first electrolyte 110 is commonly in a liquid state, and may further include an auxiliary chamber for supporting the liquid-state first electrolyte 110.

In addition, the first electrolyte 110 may be a gel or solid electrolyte rather than a liquid for fixation and manufacturing in a specific shape, and may further include a solidifying agent for solidification. The solidifying agent may include at least one of an aqueous electrolyte of a hydrogel including at least one of agarose, collagen and gelatin and a non-aqueous electrolyte of polymer-based gel including at least one of PVC and PMMA to which a plasticizer has been added, without being limited thereto.

The first electrolyte 110 may have a thickness of 0.1 mm to 1 mm, preferably 0.1 mm to 10 cm, more preferably 0.1 mm to 1 cm.

When the thickness of the first electrolyte 110 is less than 0.1 mm, it may contact the selectively permeable membrane 130, 140, or walls of the chamber for supporting the electrode 150, 151 and the first electrolyte 110. Upon contact, the electrical potential to be acquired is lost.

On the other hand, as the thickness of the first electrolyte 110 increases, the device becomes longer and the overall resistance increases, so it is desirable to use an electrolyte as thin as possible at a controllable level. Meanwhile, since both the first electrolyte 110 and the second electrolyte 120 may have high concentrations, there is a higher degree of freedom regarding thickness than existing technologies that include low concentrations.

More specifically, since low concentration has lower electrical conductivity than high concentration, resistance rises rapidly as the thickness increases. The increase in resistance causes a decrease in generated power. Since an increase in the low-concentration section with low electric capacity reduces the energy density, it can be used even in thicknesses of 1 cm or more, which are difficult to use with existing technologies due to low power generation.

The electricity generation device 100a according to an embodiment of the present invention includes the second electrolyte 120. The second electrolyte 120 may include the first electrolyte 110 and the same components.

The second electrolyte 120 may include at least two types of ions, preferably 2 to 10 types of ions.

A preferable ion composition of the second electrolyte 120 is that at least one of the ion types included in the first electrolyte 110 is not the same and is replaced with a different ion type. When the first electrolyte 110 includes three types of ions, the second electrolyte 120 may also be an electrolyte containing the same types of ions as the first electrolyte 110 at different concentrations.

Alternatively, a preferable ion composition of the second electrolyte 120 is that both the cation and anion contained in the first electrolyte 110 are not contained, but replaced with another cation and anion. An electrolyte including the cation and anion of the first electrolyte contains at low concentrations, but containing other cations and anions at high concentrations is also possible.

That is, each of the first electrolyte 110 and the second electrolyte 120 includes different two types of cations or anions. One of the two types of cation or anion may have a higher permeability for the selectively permeable membrane 130, 140, and another one thereof may have low permeability.

According to an embodiment, when each of the first electrolyte 110 and the second electrolyte 120 includes at least two types of anions, they may selectively permeate one type of anions thereof, and when the first electrolyte 110 and the second electrolyte 120 include at least two types of anions, they may selectively permeate one type of anions thereof. This may be the same in the case of cations.

More specifically, at least one type of ions, which permeate the selectively permeable membrane 130, 140, among at least three types of ions included in the first electrolyte 110 and the second electrolyte 120 may be present at different concentrations in the first electrolyte 110 and the second electrolyte 120, but the total concentrations thereof in the first electrolyte 110 and the second electrolyte 120 may be similar.

With regard to the different concentrations in the first electrolyte 110 and the second electrolyte 120, a ratio (C_{low concentration}/C_{high concentration}) of the concentration of at least one type of ions that permeate the selectively permeable membrane 130, 140 contained in the electrolyte (the first electrolyte or the second electrolyte) in which at least one type of ions permeating the selectively permeable membrane 130, 140 are contained in a relatively small amount to the concentration of at least one type of ions that permeate the selectively permeable membrane 130, 140 of the electrolyte (the second electrolyte or the first electrolyte) in which at least one type of ions permeating the selectively permeable membrane 130, 140 are contained in a relatively large amount, i.e., the concentration ratio of the selected ions, may be 0 to 0.1. In addition, the total concentration ratio (C_{second electrolyte}/C_{first electrolyte}) of the first electrolyte 110 to the second electrolyte 120 may be 0.1 to 10.

When the selected ion concentration ratio (C_{low concentration}/C_{high concentration}), i.e., the concentration ratio of the selected ions, the ions in the electrolyte containing the ions at a low concentration to the ions in the electrolyte containing the ions at a high concentration is 0, the selected ions are contained in only one electrolyte (the first electrolyte or the second electrolyte) and the total concentration ratio is 0.1 to 10, the other electrolyte (the second electrolyte or the first electrolyte) necessarily other ions at a concentration of 0.1 or more. Due to electrical neutrality, both positive and negative ions are further contained, and the total concentration ratios can be set to a similar level regardless of whether the selected ions are cations or anions.

In addition, when the concentration ratio of the selected ions is not 0 (but, <0.1), the selected ions are contained in both the electrolytes. However, since the total concentration ratio is 0.1 to 10, both the electrolytes (the first electrolyte and the second electrolyte) also contain other types of ions in an appropriate amount. Accordingly, the concentration ratio is 0.1 or less if considering only the selected ions, but other types of ions are necessarily contained such that the total concentration ratio containing the other types of ions is 0.1 or more.

According to an embodiment, the first electrolyte 110 and the second electrolyte 120 contain the same two types of cations or anions, but one of the two types of ions is contained at a high concentration in the first electrolyte 110, and the other one is contained at a high concentration in the second electrolyte 120. Accordingly, one of the two types of cations and anions may have a higher permeability through the selectively permeable membrane 130, 140, and the other ion type may have a low permeability therethrough.

For example, when the selectively permeable membrane 130, 140 distinguishes the charge amount (valence) of ions, the electricity generation device 100a according to an embodiment of the present invention may include multivalent ions such as Mg²⁺ or Ca²⁺ different from two or more types of ions contained in the second electrolyte 120 and the first electrolyte 110, and the sizes of ions are distinguished, large-sized polyatomic ions such as Co(NH₃)₆³⁺ or (CH³)ₙNHₘ⁺ may be included, without being limited thereto.

The second electrolyte 120 may include preferably different types of ions in the solvent the same as in the first electrolyte 110, and when the first electrolyte 110 and the second electrolyte 120 include a total of three types of ions, the second electrolyte 120 includes ions the same as in the first electrolyte 110. Here, the ions may be included at different concentrations from concentrations of the ions contained in the first electrolyte 110.

That is, the first electrolyte 110 and the second electrolyte 120 include a total of three types of ions. Among the ions contained in the second electrolyte 120, ions different from the ions contained in the first electrolyte 110 may depend upon the selectivity of the selectively permeable membrane 130, 140.

In addition, respective concentrations of at least two types of ions contained in the second electrolyte 120 may be the same or different.

The total concentration of the second electrolyte 120 may be high for high electrical conductivity. The total concentration of the second electrolyte 120 may be preferably 0.1 M to 5 M, more preferably, 0.1 M to 2 M.

As for the definition of high concentration, in many studies, freshwater is generally replaced with 0.01 M electrolyte and salt water is generally replaced with 0.5 M electrolyte. Considering 0.01 M electrolyte, which is expressed as freshwater, as a low concentration, 0 M to 0.1 M is defined as a low concentration. Considering 0.5 M electrolyte, which is expressed as salt water, as a high concentration, a high concentration may be defined as 0.1 M to 5 M.

Therefore, it is desirable that the total concentrations of the first electrolyte 110 and the second electrolyte 120 are at a similar level to inhibit the osmosis phenomenon, but the concentrations may vary depending on the mobility of differently included ions and the inclusion of multivalent ions.

The total concentrations of the first electrolyte 110 and the second electrolyte 120 are the same, or a difference between the total concentration of the first electrolyte 110 and the total concentration of the second electrolyte 120 is 10 times or less, so it is very small compared to the concentration difference between the ions contained in the first electrolyte 110 and the second electrolyte 120.

More specifically, it is desirable that the first electrolyte 110 and the second electrolyte 120 are at similar levels because it is expected to reduce osmosis. Whereas the total concentration ratio (C_{second electrolyte}/C_{first electrolyte}) of the first electrolyte 110 to the second electrolyte 120 according to an existing technology is at different levels of 50 to 0.02, the total concentration ratio according to the present invention is 0.1 to 10. Therefore, when exceeding the total concentration ratio (C_{second electrolyte}/C_{first electrolyte}) of the first electrolyte 110 to the second electrolyte 120 described above, the difference in concentration is similar to that of the existing technology, causing osmosis problems like the existing technology.

Therefore, the first electrolyte 110 has a concentration similar to the total concentration of the ions of the second electrolyte 120, thereby forming a stable system by limiting the flow of solvent due to osmotic pressure.

The second electrolyte 120, like the first electrolyte 110, is not limited to the liquid state but may also be a gel or solid electrolyte, and has a high concentration similar to that of the first electrolyte 110, while being as high as possible within the solubility limit according to the ions and solvent used.

Therefore, the first electrolyte 110 and the second electrolyte 120 in the electricity generation device 100a according to an embodiment of the present invention have different ion compositions or concentration compositions, but similar total concentrations. Accordingly, a quasi-equilibrium state is achieved due to the low osmotic pressure and the Donan effect of the two electrolytes (the first electrolyte and the second electrolyte), thereby having excellent electrochemical stability.

The second electrolyte 120 may have a thickness of 0.1 mm to 1 mm, preferably 0.1 mm to 10 cm, more preferably 0.1 mm to 1 cm.

When the thickness of the second electrolyte 120 is less than 0.1 mm, it may contact the selectively permeable membrane 130, 140, or walls of the chamber for supporting the electrode 150, 151 and the second electrolyte 120. Upon contact, the electrical potential to be acquired is lost.

On the other hand, as the thickness of the second electrolyte 120 increases, the device becomes longer and the overall resistance increases, so it is desirable to use an electrolyte as thin as possible at a controllable level. Meanwhile, since both the first electrolyte 110 and the second electrolyte 120 may have high concentrations, there is a higher degree of freedom regarding thickness than existing technologies that include low concentrations.

More specifically, since low concentration has lower electrical conductivity than high concentration, resistance rises rapidly as the thickness increases. Since the increase in resistance causes a decrease in generated power, it can be used even in thicknesses of 1 cm or more, which are difficult to use with existing technologies due to low power generation.

The electricity generation device 100a according to an embodiment of the present invention includes the selectively permeable membrane 130, 140 that selectively permeates at least one type of ions among at least three types of ions to cause the Donnan effect between the first electrolyte 110 and the second electrolyte 120.

According to an embodiment, the selectively permeable membrane 130, 140 has a higher permeability for one type of ions among the three types of ions of the first electrolyte 110 and the second electrolyte 120 and a low permeability for one or more types of ions among the other types of ions, thereby causing the Donnan effect.

Therefore, the electricity generation device 100a according to an embodiment of the present invention may generate electric potential caused by the ion layer due to the Donnan effect caused by the selectively permeable membrane 130, 140.

More specifically, the selectively permeable membrane 130, 140 for cation/anion or specific ions ideally aim to be completely impermeable to ions except for specific ions, but commercially available or researched ion-selective permeable membranes, which include ion-selective channels in living organisms, are not completely impermeable to ions except for specific ions. Therefore, the relative permeability may cause the Donnan effect.

In a situation where there are two cations and one anion, the Donnan effect may occur if there is a difference in permeability between the two cations (with respect to one cation) (higher permeability) even if the two cations are permeable (i.e., one anion is relatively impermeable compared to the two cations). The two cations, which are permeated, and the two cations, which have different permeability, may be the same or different.

When the selectively permeable membrane 130, 140 selectively permeates at least two types of ions among at least three types of ions, there are ions (e.g., cations) that are impermeable even if two or more types of ions are selectively permeated. Since both the electrolytes (the first electrolyte and the second electrolyte) are at high concentrations and electrical and osmotic advantages due to similar concentrations, the present invention exhibits differences from the existing technologies.

For example, when there are various ions that are permeated through the selectively permeable membrane 130, 140 and the impermeability of the ions causes the Donnan effect, the first electrolyte 110 includes K⁺ and Na⁺ rather than one type of K⁺ as cations, and K⁺ and Na⁺ each are contained at half the concentration of K⁺ ions as when containing one type of cations. When Mg²⁺ is contained in the same way when containing one type of cations and the K⁺-selective permeable membrane 130, 140 is changed into a monovalent ion selective permeable membrane 130, 140, the same effect can be achieved due to a difference in selectivity from Mg²⁺ while permeating two types of ions.

That is, the present invention may be a system containing a total of four types of ions including two types of ions among three types of cations, K⁺, Na⁺ and Mg²⁺ and at least one type of anions (Cl⁻).

In addition, when causing the Donnan effect due to a difference in selectivity between various ions that permeate the selectively permeable membrane 130, 140, K⁺ and Mg²⁺ ions are contained in the same way as when the first electrolyte 110 contains one type of cations, and the K⁺-selective permeable membrane 130, 140 permeates monovalent ions 10 times better (P_{Mg}/P_{K}=0.1), the different concentration difference of K⁺ with higher selectivity can have a dominant effect even if Mg²⁺ is at a different concentration in the two electrolytes, resulting in the same effect.

According to an embodiment, the selectively permeable membrane 130, 140 requires high selectivity for only one type of ions out of two types of ions having the same polarity to have high permeability for only the one type of ions. For this, The selectively permeable membrane 130, 140 may be adjusted to have high selectivity for only one type of ions by adding an additional selectivity function to the commonly used cation-permeable membrane or anion-permeable membrane.

Therefore, the selectively permeable membranes 130 and 140 are located between the first electrolyte 110 and the second electrolyte 120, and the selectively permeable membranes 130 and 140, unlike conventionally used cation exchange membranes or anion exchange membranes, have specific selectivity only for specific ions, thereby individually controlling a difference in concentration of ions.

For example, when the first electrolyte 110 includes a monovalent cation and the second electrolyte 120 includes a divalent cation, the selectively permeable membrane 130, 140 includes a monovalent cation-selective membrane as the selectively permeable membrane 130, thereby selectively permeating the monovalent cation membrane contained in the first electrolyte 110 to individually control the concentration of ions.

When the selectively permeable membrane 130, 140 has high permeability for one type of ions, contained in only one electrolyte, among ions constituting the first electrolyte 110 and the second electrolyte 120, this is desirable in causing strong Donnan effect. However, when both the two electrolytes (the first electrolyte and the second electrolyte) contain three types of ions, asymmetric permeability for cations and anions is provided due to different permeability for all types of the constituted ions, thereby causing the Donnan effect and electric potential.

The selectivity of the selectively permeable membrane 130, 140 may be adjusted depending upon the charge amount (valence) of ions or the size of ions, and when the selectively permeable membrane 130, 140 distinguishes the charge amount (valence) of ions, multivalent ions such as Mg²⁺ or Ca²⁺, which are included in the second electrolyte 120 and are different from the two or more types of ions contained in the first electrolyte 110, may be included. When distinguishing the sizes of ions, large-sized polyatomic ions such as Co(NH₃)₆³⁺ or (CH³)ₙNHₘ⁺ may be included, without being limited thereto.

In the selectively permeable membrane 130, 140, the permeability (P_{other ions}/P_{selected ions}) of other types of ions may have a selectivity of 0 to 0.5, compared to the permeability of one type of ions that selectively permeate the selectively permeable membrane 130, 140. When exceeding 0.5, i.e., when the selectivity is low, non-selected ions also permeate through the membrane, resulting in a great decrease in electric potential.

The selectively permeable membrane 130, 140 may have a thickness of 0.1 μm to 1 mm, preferably, 0.1 μm to 100 μm.

If the thickness of the selectively permeable membrane 130, 140 is thinner than 0.1 μm, there is a risk of damage due to weakened mechanical performance. When the thickness is thicker than 1 mm, there is concern about loss of current generated due to the large flow resistance of the selectively permeable membrane 130, 140.

The selectively permeable membrane 130, 140 of the electricity generation device according to an embodiment of the present invention may include at least one of a first selectively permeable membrane 130 and a second selectively permeable membrane 140.

It is desirable that the first selectively permeable membrane 130 and the second selectively permeable membrane 140 include only one electrolyte of the first and second electrolytes 110 and 120 or have selective permeability with a higher permeability for each of the contained cations and anion due to a great concentration difference between the two electrolytes (the first electrolyte and the second electrolyte) to cause strong Donnan effect. However, different permeability for all the ion species contained in two electrolytes (the first electrolyte and the second electrolyte) and relatively high permeability to cations and anions in each of the two selectively permeable membranes may cause the Donnan effect and electric potential.

The first selectively permeable membrane 130 may include a commercial ion exchange membrane, a 2D material functionalized to have a charged functional group or functional group (graphene, graphene oxide, etc.), a polymer-based membrane, Nafion, etc., and may be additionally modified for low selectivity for cations contained at a high concentration in the second electrolyte 120.

The first selectively permeable membrane 130 is located between is located between the first electrolyte 110 and the second electrolyte 120, and cations contained at a high concentration in the first electrolyte 110 have higher ion selectivity than cations contained at a high concentration in the second electrolyte 120, so the cations of the first electrolyte 110 may permeate more quickly.

The second selectively permeable membrane 140 is located between the second electrolyte 110 and the first electrolyte 120, the two electrolytes (the first electrolyte and the second electrolyte) are located opposite to the first selectively permeable membrane 130, and the second selectively permeable membrane 140 also causes the Donnan effect and electric potential in a similar principle to the first selectively permeable membrane 130. However, as the arrangements of the two electrolytes (the first electrolyte and the second electrolyte) are reversed, it can have a different selectivity from the first selectively permeable membrane 130 to generate an electric potential in the same direction as the first selectively permeable membrane 130.

According to an embodiment, the selectively permeable membrane 130, 140 may include a selectively permeable composite membrane including the first selectively permeable sub-membrane and second selectively permeable sub-membrane combined in parallel. This will be described in detail with reference to FIGS. 3 to 5.

According to an embodiment, the electricity generation device 100a according to an embodiment of the present invention may include an electrode connected to at least one of the first electrolyte 110 and the second electrolyte 120 to extract an electric signal.

An electrode may be used to extract an electrical signal from an electrical potential. The electrode may be inserted into the first electrolyte and the second electrolyte. Alternatively, an electrode may be inserted into one of the two electrolytes (the first electrolyte and the second electrolyte), and another electrode may be connected to the outside or ground to obtain a potential difference.

For example, when the electric potential of the electricity generation device 100a according to an embodiment of the present invention is transmitted to an external circuit with small loss, and the two electrolytes (the first electrolyte and the second electrolyte) contain Cl⁻ anions, a silver/silver chloride (Ag/AgCl)-based electrode with a low redox potential is preferably a copper/copper sulfate (Cu/CuSO₄)-based electrode when Cu²⁺ cations are contained. According to the ion compositions of the first electrolyte 110 and the second electrolyte 120 and the purpose of electrode connection, gold (Au), platinum (Pt), copper (Cu), carbon (C) or other highly conductive materials may be included or replaced for redox reaction or the stability of electrode polarization state.

In addition, two types of electrodes made of different materials may be used according to the ion compositions of the first electrolyte 110 and the second electrolyte 120 and the purpose of electrode connection.

According to an embodiment, the first electrolyte 110 and the second electrolyte 120 are formed on opposite ends in a laminated structure. Here, a first electrode 150 may be injected into the first electrolyte 110, and a second electrode 151 may be injected into the second electrolyte 120.

The sizes of the first electrode 150 and the second electrode 151 may be included in the capacity of the first electrolyte 110 and second electrolyte 120 located at opposite ends.

The shape of the first electrode 150 and the second electrode 151 is preferably a wire or plate shape, and may include a fine structure that can increase the contact area for a smooth electrical/chemical reaction with the first electrolyte 110.

The first electrode 150 is made of a material suitable for electrical/chemical reaction with the first electrolyte 110, and may be either a polarizable electrode or a non-polarizable electrode. For example, when chlorine ions (Cl⁻) are included as anions of the first electrolyte 110, the first electrode 150 may be a silver/silver chloride electrode (Ag/AgCl electrode). However, the ion type of the first electrolyte 110 is not specifically limited. Accordingly, the first electrode 150 may include or be replaced with gold (Au), platinum (Pt), copper (Cu), carbon (C), etc. for redox reaction or the stability of electrode polarization state, without being limited thereto.

The second electrode 151 injected into the second electrolyte 120 may be replaced with a different material from the first electrode 150 injected into the first electrolyte 110 in accordance with the redox reaction with the second electrolyte 120 or the stability of electrode polarization state.

The electricity generation device 100a according to an embodiment of the present invention may replace freshwater with other substances, such as industrial water or groundwater, in the reverse electrodialysis technology that generates electricity by using the concentration difference between seawater and freshwater, providing higher current and power density and excellent stability of the system.

In addition, the electricity generation device 100a according to an embodiment of the present invention is identical to the cell membrane potential generation mechanism of a living body, so it may be used as an electricity generation and source for flexible robots and artificial organs.

In addition, the electricity generation device 100a according to an embodiment of the present invention may obtain higher power by utilizing reverse electrodialysis technology in a wide range of areas such as industrial water, wastewater and domestic sewage, rather than salt water and freshwater.

In addition, the electricity generation device 100a according to an embodiment of the present invention may be used as an energy source for flexible devices due to its excellent electrochemical stability and bio-friendly characteristics based on biomimicry.

In addition, the electricity generation device 100a according to an embodiment of the present invention may propose an improved renewable energy system (e.g., flow battery) as a fusion technology of the oxidation and reduction reaction of electrodes.

In addition, the electricity generation device 100a according to an embodiment of the present invention may be applied to a redox battery or a flow battery.

FIG. 2 is a schematic diagram illustrating the mechanism of an electricity generation device according to an embodiment of the present invention with a three-layer laminated structure including a selectively permeable single membrane.

Referring to FIG. 2, in the electricity generation device according to an embodiment of the present invention with a three-layer laminated structure including a selectively permeable single membrane, a first electrolyte may contain a high concentration of A⁺ cations and a low concentration of B⁻ anions, and a second electrolyte may contain a high concentration of C⁺ cations and B⁻ anions.

Here, the first selectively permeable membrane is located between the first electrolyte and the second electrolyte, and A⁺ cations contained at a high concentration in the first electrolyte have higher ion selectivity than C⁺ cations contained at a high concentration in the second electrolyte, so that the A⁺ cations of the first electrolyte may permeate more quickly.

Meanwhile, since B⁻ anions contained in the first electrolyte and the second electrolyte have ion selectivity at similar levels, the ion selectivity for B⁻ anions may be very low.

Therefore, electrical and osmotic equilibrium is achieved between the first electrolyte and the second electrolyte, resulting in a weak osmosis phenomenon and ensuring excellent stability (osmosis-resistive) from the osmosis phenomenon.

In addition, since the total concentration of ions in each of the first electrolyte and the second electrolyte is high, high current density and power may be secured by achieving electrochemical equilibrium.

FIG. 3 is a sectional view illustrating an electricity generation device according to an embodiment of the present invention including a selectively permeable composite membrane.

A selectively permeable membrane included in an electricity generation device 110b according to an embodiment of the present invention may be a selectively permeable composite membrane 131, 141 including a first selectively permeable sub-membrane and second selectively permeable sub-membrane combined in parallel.

Two selectively permeable composite membranes 131 and 141 having high permeability for one type of ions, contained at a high concentration in the first electrolyte 110, and ions of the other pole which are contained at a high concentration in the second electrolyte 120 may be combined in parallel.

In addition, the two selectively permeable composite membranes 131 and 141 respectively having a higher permeability and a low permeability for one type of ions contained at a high concentration in the first electrolyte 110 and other types of ions of the same pole contained at a high concentration in the second electrolyte 120 may be combined in parallel.

That is, the two selectively permeable composite membranes 131 and 141 may respectively have a high permeability and low permeability for cations or anions contained at a high concentration in the first electrolyte 110 and other types of ions of the same pole contained at a high concentration in the second electrolyte 120.

Preferably, since the selectively permeable membrane has selectivity for one type of ions, the electricity generation device 110b according to an embodiment of the present invention may form asymmetrical permeability for two types of ions by including the selectively permeable composite membranes 131 and 141.

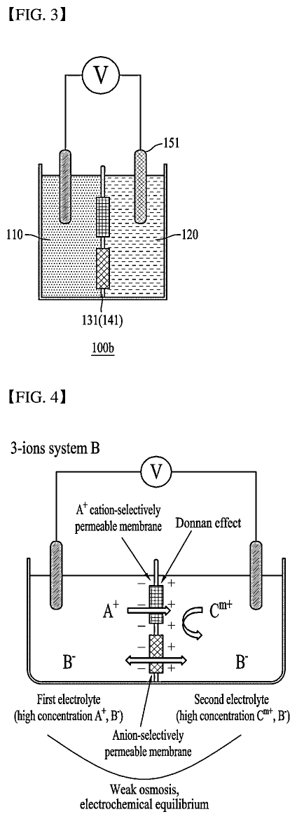

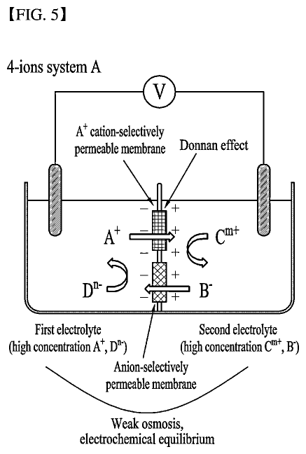

FIGS. 4 and 5 are schematic diagrams illustrating the mechanism of the electricity generation device according to an embodiment of the present invention including a selectively permeable composite membrane.

The permeability of the selectively permeable membrane only for one type of ions requires high selectivity only for one type of ions among two types of ions of the same pole. An additionally processed selective permeation membrane is generally used to provide additional selectivity to a cation/anion-selectively permeable membrane, or asymmetrical permeability may be formed with a selectively permeable composite membrane in which two different types of selectively permeable membranes having a higher permeability due to different types of ions, are formed in parallel.

Referring to FIG. 4, in the electricity generation device according to an embodiment of the present invention including a selectively permeable composite membrane, the first electrolyte may include A⁺ cations and B⁻ anions, and the second electrolyte may include C^{m+} cation and B⁻ anions.

In addition, a selectively permeable composite membrane including a first selectively permeable sub-membrane and second selectively permeable sub-membrane combined in parallel may be included between the first electrolyte and the second electrolyte.

Here, the first selectively permeable sub-membrane has higher ion selectivity for A⁺ cations contained in the first electrolyte than C^{m+} cations contained in the second electrolyte, thereby having a higher permeability for A⁺ cations, and the second selectively permeable sub-membrane has anion selectivity for B⁻ anions contained in the first electrolyte and second electrolyte, thereby having a higher permeability.

Therefore, both electrical and osmotic equilibrium are achieved between the first electrolyte and the second electrolyte, so a weak osmosis phenomenon occurs, thereby ensuring excellent stability (osmosis-resistive) from the osmosis phenomenon.

Referring to FIG. 5, in the electricity generation device according to an embodiment of the present invention including a selectively permeable composite membrane, the first electrolyte may contain a high concentration of A⁺ cations and Dⁿ⁻ anions, and the second electrolyte may contain a high concentration of C^{m+} cations and a high concentration of B⁻ anions.

Here, the first selectively permeable sub-membrane has higher ion selectivity for A⁺ cations contained at a high concentration in the first electrolyte than C^{m+} cations at a high concentration contained in the second electrolyte, thereby having a higher permeability for A⁺ cations, and the second selectively permeable sub-membrane has anion selectivity for B⁻ anions contained in the first electrolyte and second electrolyte, thereby having a higher permeability

In addition, the second selectively permeable sub-membrane has higher ion selectivity only for a high concentration of B⁻ anions contained in the second electrolyte, thereby having a high permeability for B⁻ anions.

Therefore, both electrical and osmotic equilibrium are achieved between the first electrolyte and the second electrolyte, so a weak osmosis phenomenon occurs, thereby ensuring excellent stability (osmosis-resistive) from the osmosis phenomenon.

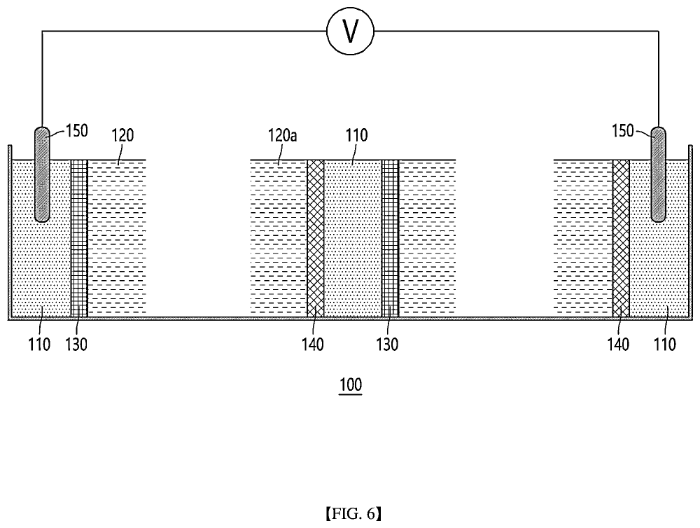

FIGS. 6 and 7 are sectional views illustrating electricity generation devices according to an embodiment of the present invention laminated in a laminated structure.

An electricity generation device 100 having a laminated structure (having a multilayer structure) according to an embodiment of the present invention includes a first electrolyte 110, selectively permeable membranes 130 and 140, and second electrolyte 120 in a chamber thereof, wherein the first electrolyte 110, the selectively permeable membranes 130 and 140, and the second electrolyte 120 are alternately and repeatedly stacked in a laminated structure. Each of the first electrolyte 110 and the second electrolyte 120 contains at least two types of ions, a total of at least three types are contained in the first electrolyte 110 and the second electrolyte 120, and the selectively permeable membranes 130 and 140 selectively permeate at least one type of ions among at least three types of ions, thereby causing the Donnan effect between the first electrolyte 110 and the second electrolyte 120.

Preferably, between the first electrolytes 110 formed at both ends of the chamber of the electricity generation device 100 with a laminated structure according to an embodiment of the present invention, the first electrolyte/the selectively permeable membrane/the second electrolyte or the second electrolyte/the selectively permeable membrane/the first electrolyte may be alternately and repeatedly laminated.

The electricity generation device 100 with a laminated structure according to an embodiment of the present invention includes the same components as the electricity generation device according to an embodiment of the present invention, except that the first electrolyte 110, the selectively permeable membranes 130 and 140 and the second electrolyte 120 are repeatedly laminated, so descriptions of the same components are omitted.

The electricity generation device 100 with a laminated structure according to an embodiment of the present invention may include at least two selectively permeable membranes 130 and 140, and preferably, the electricity generation device 100 with a laminated structure according to an embodiment of the present invention may include the first selectively permeable membrane 130 and the second selectively permeable membrane 140.

The relatively excellent permeability of the first selectively permeable membrane 130 for cations causes problems with the electroneutrality of the first electrolyte 110 and the second electrolyte 120, and as ions of the two electrolytes (the first electrolyte and the second electrolyte) form an ion layer around the first selectively permeable membrane 130, the permeability of the first electrolyte 110 for cations is limited.

Preferably, the first selectively permeable membrane 130 is a commercially available monovalent cation-selective exchange membrane or is manufactured by coating the surface of a functionalized cation-permeable membrane with a monovalent negative functional group or functional group at a high density, thereby having high selectivity for a monovalent cation contained in the first electrolyte and low selectivity for multivalent cations contained in the second electrolyte. Alternatively, by using a charged membrane composed of nanochannels, the first selectively permeable membrane 130 may have high selectivity for small-sized cations that the first electrolyte 110 contains at a high concentration while having low selectivity for large-sized cations that the second electrolyte 120 contains at a high concentration.

However, this is an example of a method for causing a relative selectivity difference for the cations of the first electrolyte 110 and the second electrolyte 120, but the present invention is not limited thereto.

The second selectively permeable membrane 140 is located between the second electrolyte 110 and the first electrolyte 120, so the two electrolytes (the first electrolyte and the second electrolyte) may be located opposite to the first selectively permeable membrane 130. The second selectively permeable membrane 140 also causes the Donnan effect and electric potential in a similar principle to the first selectively permeable membrane 130. However, as the arrangements of the two electrolytes (the first electrolyte and the second electrolyte) are reversed, it can have a different selectivity from the first selectively permeable membrane 130 to generate an electric potential in the same direction as the first selectively permeable membrane 130.

Commonly, the second selectively permeable membrane 140 may replace the Donnan effect method applied to cations by the first selectively permeable membrane 130 with anions. Preferably, the second selectively permeable membrane 140 is a selectively permeable membrane functionalized with the opposite pole, and may be further improved for the low selectivity of the second electrolyte 120 to anions. Preferably, the second selectively permeable membrane 140, which is a commercially available monovalent anion-selective exchange membrane or a membrane coated with a material having a monovalent positive functional group, may have high selectivity for a monovalent anion contained in the first electrolyte 110 and low selectivity for a multivalent anion contained in the second electrolyte 120.

Alternatively, the second selectively permeable membrane 140 may include an oppositely charged membrane made of nanochannels, thereby high selectivity for small-sized anions contained in the first electrolyte 110 and low selectivity for large-sized anions contained in the second electrolyte 120.

However, this is an example of a method for causing a relative difference in selectivity for anions of the first electrolyte 110 and the second electrolyte 120, and the present invention is not limited thereto.

In addition, the high anion selectivity of the second selectively permeable membrane 140 is commonly accompanied by low anion selectivity, and to improve the current and power density of the electricity generation device 100, a selectively permeable composite membrane in which cation-permeable membranes are combined in parallel may be used as the second selectively permeable membrane.

Meanwhile, the second selectively permeable membrane 140 may be used to selectively permeate cations as in the first selectively permeable membrane 130.

When the second selectively permeable membrane 140 is manufactured by coating it with a material having a multivalent functional group, contrary to the first selectively permeable membrane 130, it has higher selectivity for multivalent ions, thereby causing the Donan phenomenon opposite to the first selectively permeable membrane 130.

The arrangement of the first electrolyte 110 and the second electrolyte 120 formed on both sides of the second selectively permeable membrane 140 may cause the opposite Donan phenomenon on the second selectively permeable membrane 140 which is opposite to the first selectively permeable membrane 130, thereby generating an electric potential in the same direction as the first selectively permeable membrane 130.

Therefore, the first selectively permeable membrane 130 and the second selectively permeable membrane 140 may selectively permeate different types of ions and may form an electric potential in the same direction.

The same direction means that the electric potential generated from the first selectively permeable membrane 130 and second selectively permeable membrane 140 laminated in series can add an electric potential magnitude in the same pole direction (+|− then +|−).

That is, the first selectively permeable membrane 130 and the second selectively permeable membrane 140 have higher permeability for different types of ions, and, as the first electrolyte 110 and the second electrolyte 120 are arranged oppositely at both ends thereof, may form an electric potential in the same direction.

Therefore, the electricity generation device 100 with a laminated structure according to an embodiment of the present invention includes a structure wherein the first electrolyte 110, the selectively permeable membranes 130 and 140 and the second electrolyte 120 are sequentially laminated. Since both the first electrolyte 110 and the second electrolyte 120 include different types of ions at high concentrations or three types of ions at different concentrations, the Donnan effect in which electric potential is spontaneously generated may occur due to a concentration gradient of ions that permeate the selectively permeable membranes 130 and 140.

Preferably, the electricity generation device 100 with a laminated structure according to an embodiment of the present invention may include the first electrolyte 110, the first selectively permeable membrane 130, the second electrolyte 120, the second selectively permeable membrane 140 and the first electrolyte 110, as shown in FIG. 7.

More specifically, the electricity generation device 100 with a laminated structure according to an embodiment of the present invention may include the first electrolyte 110, the first selectively permeable membrane 130 adjacent to the first electrolyte, the second electrolyte 120 opposite to the first electrolyte and adjacent to the first selectively permeable membrane, the second selectively permeable membrane 140 opposite to the first selectively permeable membrane and adjacent to the second electrolyte, and the first electrolyte 110 opposite to the second electrolyte and adjacent to the second selectively permeable membrane. The laminated structure may be repeated, and an electrode may be inserted into the first electrolyte 110 or second electrolyte 120 located at opposite ends of the laminated structure.

Therefore, the electricity generation device 100 with a laminated structure according to an embodiment of the present invention includes a five-layer laminated structure due to inclusion of two types of selectively permeable membranes. Here, the two types of selectively permeable membranes and the two types of electrolytes (the first electrolyte and the second electrolyte) are alternately and repeatedly laminated, thereby implementing a device in which the Donnan effect and the generation of electric potential are accumulated in the same direction.

That is, the electricity generation device 100 with a laminated structure according to an embodiment of the present invention may be laminated in series to increase the total electric potential (voltage).

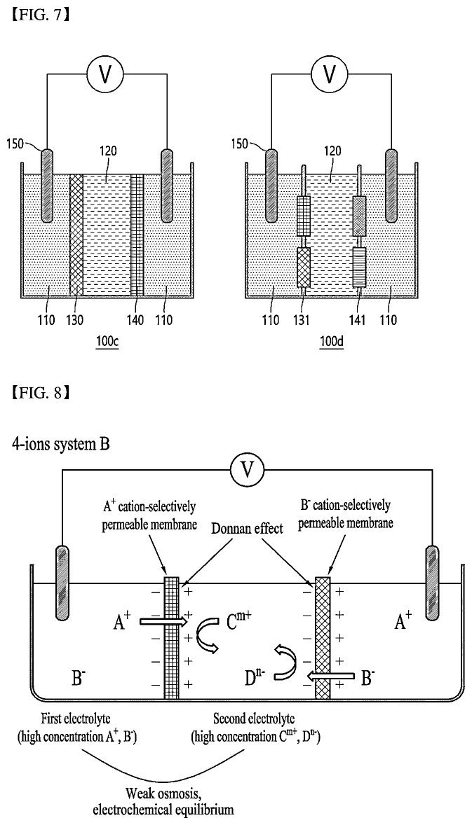

Hereinafter, the mechanism of the electricity generation device with the laminated structure according to an embodiment of the present invention of FIG. 7 is described with reference to FIGS. 8 to 10.

FIGS. 8 to 10 are schematic diagrams illustrating the mechanism of the electricity generation device with a laminated structure according to an embodiment of the present invention.

Referring to FIG. 8, the electricity generation device with a laminated structure according to an embodiment of the present invention includes two types of selectively permeable membranes and includes a structure wherein a first electrolyte, a first selectively permeable membrane, a second electrolyte, a second selectively permeable membrane and a first electrolyte are sequentially laminated. Here, both the first electrolyte and the second electrolyte may be contained at high concentrations.

Ions of different polarities (positive and negative) contained in the second electrolyte respectively and selectively permeate the first selectively permeable membrane and the second selectively permeable membrane with high permeability, or ions of different poles contained in the first electrolyte selectively permeate the first selectively permeable membrane and the second selectively permeable membrane, so that ions of different poles selectively permeate the first selectively permeable membrane and the second selectively permeable membrane in opposite directions to form Donnan potential of the same pole.

That is, since the second selectively permeable membrane causes the Donnan effect and generates electric potential in a similar principle to the first selectively permeable membrane, but the arrangement of the two electrolytes (the first electrolyte and the second electrolyte) is opposite to that of the first selectively permeable membrane, the second selectively permeable membrane may have selectivity different from the first selectively permeable membrane 130 to generate an electric potential in the same direction as the first selectively permeable membrane.

Specifically, in the electricity generation device with a laminated structure according to an embodiment of the present invention, the first electrolyte may contain A⁺ cations and B⁻ anions, and the second electrolyte may contain C⁺ cations and Dⁿ⁻ anions.

Here, a first selective exchange membrane may be a monovalent cation-selectively permeable membrane that selectively permeates A⁺ cations contained in the first electrolyte, and the second selective exchange membrane may be a monovalent anion-selectively permeable membrane that selectively permeates B⁻ anions contained in the first electrolyte, so that second selectively permeable membrane may replace the Donan effect method, applied to cations by the first selectively permeable membrane 130, with anions,

That is, the second selectively permeable membrane may have high selectivity for B⁻ anions as a monovalent anion contained in the first electrolyte and low selectivity for Dⁿ⁻ anions as a multivalent anion contained in the second electrolyte.

Referring to FIG. 9, the electricity generation device with a laminated structure according to an embodiment of the present invention includes two types of selectively permeable membranes and includes a structure wherein a first electrolyte, a first selectively permeable membrane, a second electrolyte, a second selectively permeable membrane and a first electrolyte are sequentially laminated. Here, both the first electrolyte and the second electrolyte may be contained at high concentrations.

In addition, the first selectively permeable membrane and the second selectively permeable membrane selectively permeate one type of ions among two types of ions of the same pole contained in the first electrolyte and the second electrolyte with high permeability, so the two selectively permeable membranes respectively and selectively permeate two types of ions of the same pole in the same direction to form the Donnan potential of the same pole.

Specifically, in the electricity generation device with a laminated structure according to an embodiment of the present invention, the first electrolyte may contain A⁺ cations and B⁻ anions, and the second electrolyte may contain C⁺ cations and Dⁿ⁻ anions (or B⁻).

Here, the first selective exchange membrane may be a monovalent cation-selectively permeable membrane that selectively permeates A⁺ cations contained in the first electrolyte, and the second selective exchange membrane may be a multivalent anion-selectively permeable membrane that selectively permeates C⁺ cations included in the first electrolyte.

That is, when the second selectively permeable membrane 140 is coated with a material having a multivalent functional group as opposed to the first selectively permeable membrane, it has higher selectivity for multivalent ions, thereby causing the Donan phenomenon opposite to that of the first selectively permeable membrane.

In the electricity generation device with a laminated structure according to an embodiment of the present invention of FIG. 9, the opposite Donan phenomenon of the second selectively permeable membrane having an electrolyte arrangement opposite to the first selectively permeable membrane may ultimately generate an electric potential in the same direction as the first selectively permeable membrane.

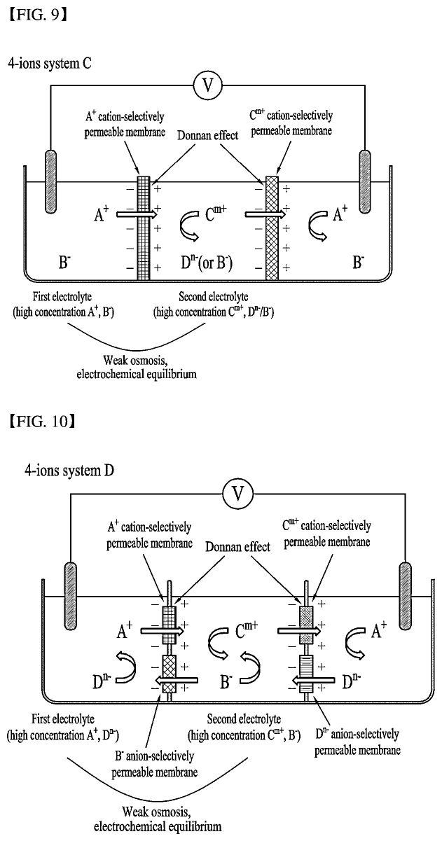

Referring to FIG. 10, the electricity generation device with a laminated structure according to an embodiment of the present invention includes two types of selectively permeable membranes and includes a structure wherein a first electrolyte, a first selectively permeable membrane, a second electrolyte, a second selectively permeable membrane and a first electrolyte are sequentially laminated. Here, both the first electrolyte and the second electrolyte may be contained at high concentrations.

At least one of the first selectively permeable membrane and the second selectively permeable membrane may be a selectively permeable composite membrane. Therefore, the electricity generation device 100 with a laminated structure according to an embodiment of the present invention may have improved current and power density.

Specifically, in the electricity generation device with a laminated structure according to an embodiment of the present invention, the first electrolyte may contain A⁺ cations and Dⁿ⁻ anions, and the second electrolyte may contain C^{m+} cations and B⁻ anions.

Here, the first selectively permeable membrane may include a first selectively permeable sub-membrane having high selectivity for A⁺ cations as a monovalent cation contained in the first electrolyte; and a second selectively permeable sub-membrane having high selectivity for B⁻ anions as a monovalent anion contained in the second electrolyte.

The second selectively permeable membrane may include a first selectively permeable sub-membrane having high selectivity for C^{m+} cations as a multivalent cation contained in the second electrolyte; and a second selectively permeable sub-membrane having high selectivity for Dⁿ⁻ anions as a multivalent anion contained in the first electrolyte.

Therefore, in the electricity generation device with a laminated structure according to an embodiment of the present invention, electric potential may be generated in the same direction by the first selectively permeable membrane and the second selectively permeable membrane and, at the same time, the current and power density may be improved.

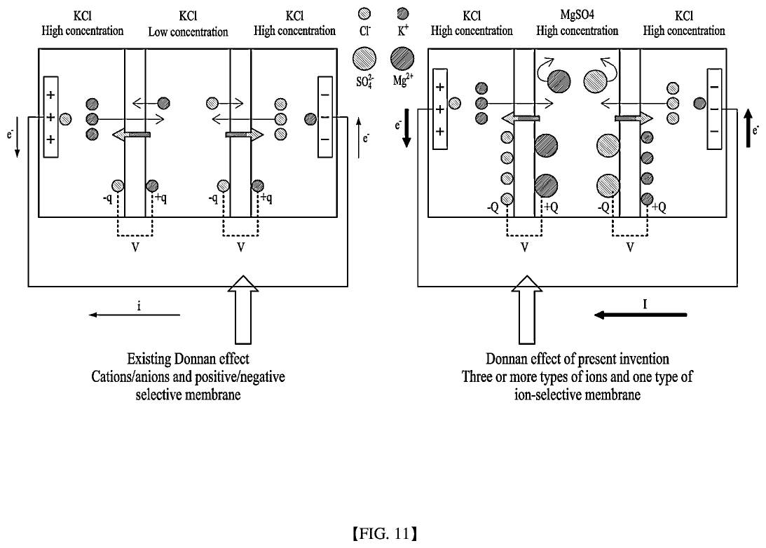

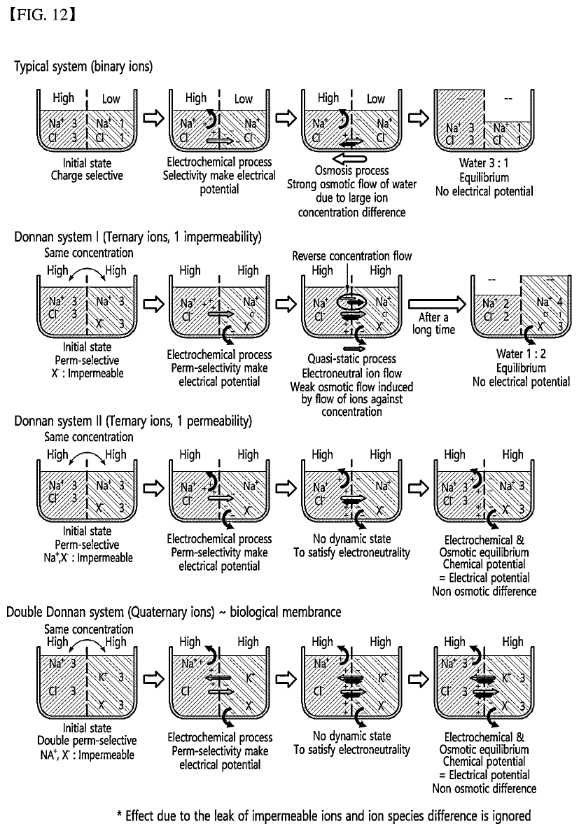

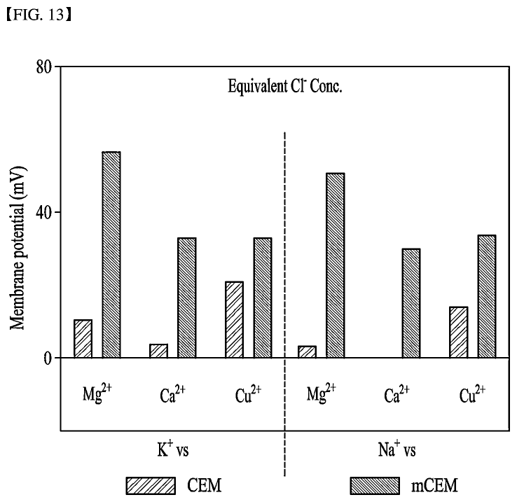

FIG. 11 illustrates sectional views for comparing an existing reverse electrodialysis technology and the electricity generation device with a laminated structure according to an embodiment of the present invention, and FIG. 12 are schematic diagram for comparing an existing reverse electrodialysis technology and the electricity generation device according to an embodiment of the present invention.

The existing reverse electrodialysis technology uses a concentration difference of at least 50 times to generate an electric potential similar to the resting potential of cells, but the electricity generation device according to an embodiment of the present invention and the electricity generation device with a laminated structure according to an embodiment of the present invention consist of various positive or negative ions and allows selective penetration of one of the ions, thereby obtaining electricity without restrictions on the total concentration.

In the existing reverse electrodialysis technology consisting of two types of ions (mainly Na⁺ and Cl⁻), a low concentration is an essential element in producing high electric potential. However, in the low concentration section, the electric conductivity and electric capacity are low and, accordingly, the power density and energy density are also low, so the power density is generally responded by repeating the series connection of high concentration-selective film-low concentration-selective film in a laminated structure to obtain high voltage. Energy density is responded in a manner of continuously supplying low- and high-concentration electrolytes from the outside using a pump device.

However, this is not a method of improving the electrical performance of a single cell (high concentration-selective membrane-low concentration-selective membrane-high concentration unit) itself, but this has limitations in that it is a method of expansion and replenishment, such as increasing the number of cells or continuously supplying external energy elements.

However, the electricity generation device according to an embodiment of the present invention and the electricity generation device with a laminated structure according to an embodiment of the present invention mimic the function of biological cells, which is different from the existing reverse electrodialysis, and the present invention consists of a high concentration of ions other than Na⁺ and Cl⁻ in the low-concentration electrolyte of the existing reverse electrodialysis technology, and uses a selectively permeable membrane that selectively transmits only Na⁺ or Cl⁻ while impermeable to other ions, thereby providing an electric power generation device with only a high concentration section.

That is, the electricity generation device according to an embodiment of the present invention and the electricity generation device with a laminated structure according to an embodiment of the present invention do not select one of Na⁺ and Cl⁻, but rather select one of Na⁺ and other cations, and one of Cl⁻ and other anions. Accordingly, all electrolytes are used at high concentrations, so the absence of low concentrations can improve the electrical performance (energy density and power density) of a single cell itself.

Additionally, in similar manners as in cells, the electricity generation device according to an embodiment of the present invention and the electricity generation device with a laminated structure according to an embodiment of the present invention can solve problems (reduction in concentration difference, maintenance of system form, etc.) which may occur due to water movement due to osmotic pressure when the concentrations of the two electrolytes (first electrolyte and second electrolyte) are similar.

Therefore, the electricity generation device according to an embodiment of the present invention and the electricity generation device with a laminated structure according to an embodiment of the present invention may secure high current and power by using only high-concentration electrolytes, may secure excellent stability (osmosis-resistive) from osmotic phenomena by using the first electrolyte and second electrolyte at the same concentration, and may secure electrochemical stability (electrochemical equilibrium) for a long time by utilizing the intact Donnan effect of cells.

### Example 1

An electricity generation device laminated in a three-layer structure that included a 1 M aqueous solution of KCl and NaCl as the first electrolyte, a 0.5 M aqueous solution of CaCl₂, MgCl₂ and CuCl₂ as the second electrolyte, a monovalent cation exchange membrane as a first selectively permeable membrane and Ag/AgCl as an electrode was prepared.

### Comparative Example 1

An electricity generation device was prepared in the same manner as in Example 1 except that the first selectively permeable membrane was replaced with a commercial general cation exchange membrane.

### Experimental Example 1: Measurement of Electric Potential Dependent Upon Selectively Permeable Membrane

FIG. 13 illustrates the electric potentials of the electricity generation device according to Comparative Example 1 and the electricity generation device of Example 1 according to the present invention.

Referring to FIG. 13, it can be seen that in the electricity generation device according to Comparative Example 1, a low electric potential was measured because a general cation exchange membrane was used between two electrolytes with a very small concentration difference, but in the electricity generation device of Example 1 according to the present invention, the Donnan effect was induced and a high electric potential was obtained due to use of a monovalent cation exchange membrane with excellent selectivity.

### Example 2: mCE M 1 MgSO₄ 0.5 M 1 mAE M

An electricity generation device laminated in a five-layer structure that included a 1 M aqueous solution of KCl as the first electrolyte, a 0.5 M aqueous solution of MgSO₄ as the second electrolyte, a monovalent cation exchange membrane as the first selectively permeable membrane, an anion exchange membrane and monovalent anion exchange membrane as the second selectively permeable membranes and Ag/AgCl as an electrode was prepared.

### Comparative Example 2: CE M 1 MgSO₄ 0.5 M 1 AE M

An electricity generation device was prepared in the same manner as in Example 2 except that a commercial general cation exchange membrane was used as the first selectively permeable membrane and the second selectively permeable membrane was replaced with a commercial general anion exchange membrane.

### Comparative Example 3: CE M 1 MgSO₄ 0.1 M 1 AE M

An electricity generation device was prepared in the same manner as in Example 2 except that a 0.1 M aqueous solution of KCl was used as the second electrolyte, a commercial general cation exchange membrane was used as the first selectively permeable membrane, and the second selectively permeable membrane was replaced with a commercial general anion exchange membrane.

### Comparative Example 4: CE M 1 MgSO₄ 0.01 M 1 AE M

An electricity generation device was prepared in the same manner as in Example 2 except that a 0.01 M aqueous solution of KCl was used as the second electrolyte, a commercial general cation exchange membrane was used as the first selectively permeable membrane, and the second selectively permeable membrane was replaced with a commercial general anion exchange membrane.

### Experimental Example 2: Characteristics Dependent Upon Concentration and Selectively Permeable Membrane

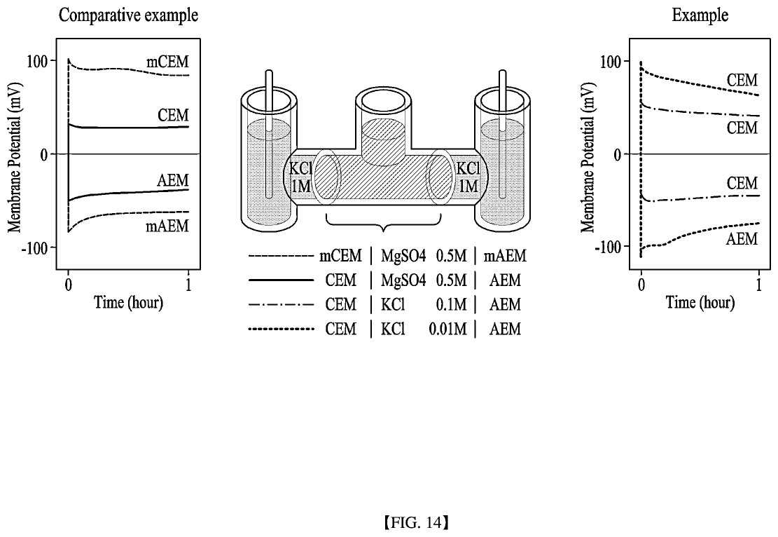

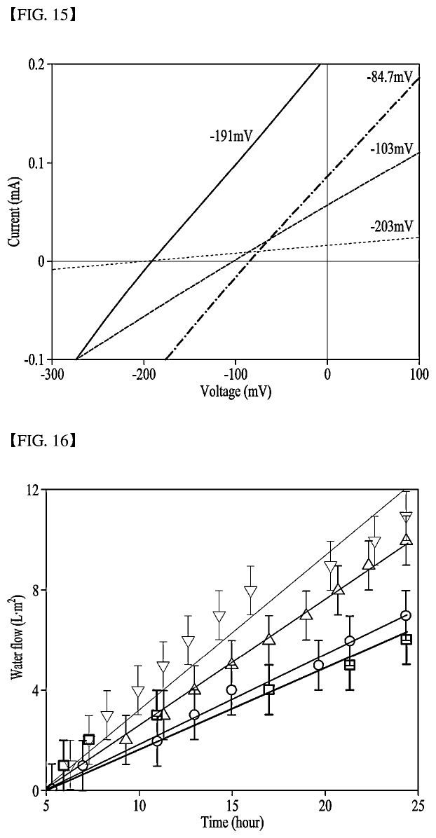

FIG. 14 illustrates the electrochemical stability of the electricity generation devices according to Comparative Examples 2 to 4 and of the electricity generation device according to Example 2 of the present invention, and FIG. 15 illustrates the voltage-current characteristics of the electricity generation devices according to Comparative Examples 2 to 4 and of the electricity generation device according to Example 2 of the present invention.

Referring to FIG. 14, in the case of the electricity generation device according to Comparative Example 2, a low electric potential was measured because a general cation exchange membrane was used between two electrolytes having a very small concentration difference, but in the case of the electricity generation device according to Example 2 of the present invention, the Donnan effect was caused due to use of the monovalent cation exchange membrane having excellent selectivity for monovalent ions, thereby obtaining a high electric potential.

Therefore, it can be seen that the electricity generation device according to Example 2 of the present invention maintains a stable electrochemical state compared to the electricity generation device according to Comparative Example 2.

In addition, the electricity generation devices according to Comparative Examples 3 and 4 obtained an electric potential by a large concentration difference, similar to existing electrodialysis devices, and the electricity generation device according to Comparative Example 4 in which the concentration difference was 100 times greater could obtain an electric potential of a similar level to the electricity generation device according to the present invention of Example 2.

However, referring to FIG. 15, the electricity generation devices according to Comparative Examples 3 and 4 obtain a low zero-voltage current due to the second electrolyte at a low concentration. On the other hand, the electricity generation device according to the present invention of Example 2 can obtain a very high zero voltage current due to the excellent electrical conductivity of the high concentration of the second electrolyte.

Therefore, it can be seen that the electricity generation device according to Example 2 of the present invention can obtain a very high current of about 10 times that of the electricity generation devices according to Comparative Examples 3 and 4.

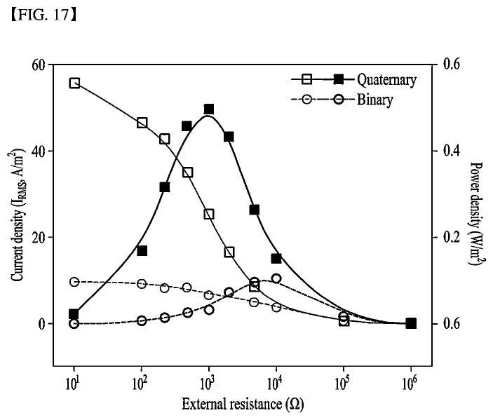

FIG. 16 illustrates the osmotic pressure characteristics of the electricity generation devices according to Comparative Examples 2 to 4 and of the electricity generation device according to Example 2 of the present invention.

Referring to FIG. 16, it can be seen that the electricity generation devices according to Comparative Examples 3 and 4 receive a large amount of osmotic pressure in the osmosis test due to a large concentration difference between the first electrolyte and the second electrolyte, but the osmotic pressure of the electricity generation device of the present invention according to Example 2 is halved, compared to the electricity generation devices according to Comparative Examples 3 and 4.

FIG. 17 illustrates the current density characteristics of the electricity generation device (Binary) according to Comparative Example 4 and of the electricity generation device (Quaternary) according to Example 2 of the present invention.

Referring to FIG. 17, it can be seen that the current density characteristics of the electricity generation device (Quaternary) of the present invention according to Example 2 are increased by 5 times compared to the electricity generation device (Binary) according to Comparative Example 4, and the maximum power density thereof is increased by about 5 times.

Although the present invention has been described through limited examples and figures, the present invention is not intended to be limited to the examples. Those skilled in the art will appreciate that various modifications, additions and substitutions are possible, without departing from the scope and spirit of the invention. Therefore, it should be understood that there is no intent to limit the invention to the embodiments disclosed, rather, the invention is to cover all modifications, equivalents, and alternatives falling within the spirit and scope of the invention as defined by the claims.

1. An electricity generation device, comprising: a first electrolyte, selectively permeable membrane, and second electrolyte in a chamber thereof,
wherein each of the first electrolyte and the second electrolyte comprises at least two types of ions, and at least three types of ions are comprised in the first electrolyte and the second electrolyte,
the selectively permeable membrane selectively permeates at least one type of ions among the at least three types of ions to cause Donnan effect between the first electrolyte and the second electrolyte.

2. The electricity generation device according to claim 1, wherein in the selectively permeable membrane, a permeability (P_{other ions}/P_{selected ions}) of other types of ions relative to a permeability of one type of ions that selectively permeate the selectively permeable membrane is 0 to 0.5.

3. The electricity generation device according to claim 1, wherein at least one type of ions, which permeate the selectively permeable membrane, among at least three types of ions comprised in the first electrolyte and the second electrolyte are present at different concentrations in the first electrolyte and the second electrolyte.

4. The electricity generation device according to claim 3, wherein, with regard to the different concentrations between the first electrolyte and the second electrolyte,
a ratio (C_{low concentration}/C_{high concentration}) of a concentration of at least one type of ions, which permeate the selectively permeable membrane, comprised in an electrolyte in which at least one type of ions permeating the selectively permeable membrane is comprised in a relatively small content to a concentration of at least one type of ions, which permeate the selectively permeable membrane, comprised in an electrolyte in which at least one type of ions permeating the selectively permeable membrane are contained in a relatively large amount is 0 to 0.1.

5. The electricity generation device according to claim 3, wherein a total concentration ratio (C_{second electrolyte}/C_{first electrolyte}) of the first electrolyte to the second electrolyte is 0.1 to 10.

6. The electricity generation device according to claim 1, wherein the first electrolyte comprises cations and anions,
wherein the cations comprise at least one of H⁺, Na⁺, K⁺, Mg²⁺, Ca²⁺, Li⁺, Fe³⁺, Fe²⁺, Al³⁺, Cu²⁺, Zn²⁺, Zn⁺, V²⁺, V³⁺, Cr²⁺, Cr³⁺, Co(NH₃)₆³⁺ and (CH₃)ₙNHₘ⁺ (n and m are from 0 to 4, and the sum of n and m is 4), and
the anion comprises at least one F⁻, Cl⁻, Br⁻, NO₃⁻, OH⁻, F⁻, Br⁻, HCO₃⁻, SO₄²⁻ and CO₃²⁻.

7. The electricity generation device according to claim 1, wherein the selectively permeable membrane comprises a selectively permeable composite membrane comprising a first selectively permeable sub-membrane and second selectively permeable sub-membrane combined in parallel.

8. The electricity generation device according to claim 1, wherein a thickness of the first electrolyte and the second electrolyte is 0.1 mm to 1 mm.

9. The electricity generation device according to claim 1, wherein a thickness of the selectively permeable membrane is 0.1 μm to 1 mm.

10. The electricity generation device according to claim 1, wherein an electrode is further comprised in at least one of the first electrolyte and the second electrolyte.

11. An electricity generation device with a laminated structure, the electricity generation device comprising: a first electrolyte, selectively permeable membrane, and second electrolyte in a chamber thereof,
wherein the first electrolyte, the selectively permeable membrane and the second electrolyte are alternately and repeatedly stacked in a laminated structure,
each of the first electrolyte and the second electrolyte comprises at least two types of ions, and at least three types of ions are comprised in the first electrolyte and the second electrolyte,
the selectively permeable membrane selectively permeates at least one type of ions among the at least three types of ions to cause Donnan effect between the first electrolyte and the second electrolyte.

12. The electricity generation device according to claim 11, wherein the selectively permeable membrane is composed of at least two membranes.

13. The electricity generation device according to claim 12, wherein the selectively permeable membrane comprises a first selectively permeable membrane and a second selectively permeable membrane,
wherein the first selectively permeable membrane and the second selectively permeable membrane selectively permeate different types of ions and form electric potential in a same direction.
